(19) United States
(12) Patent Application Publication
(10) Pub. No.: US 2021/0232419 A1
(43) Pub. Date: Jul. 29, 2021

(54) CANARY PROCESS FOR GRACEFUL WORKLOAD EVICTION

(71) Applicant: VMware, Inc., Palo Alto, CA (US)

(72) Inventors: Daniel MUELLER, Palo Alto, CA (US); Adrian DRZEWIECKI, Cupertino, CA (US)

(21) Appl. No.: 16/751,544

(22) Filed: Jan. 24, 2020

(51) Int. Cl. G06F 9/455

(52) U.S. Cl. CPC G06F 9/45558; G06F 2009/45575; G06F 2009/45591; G06F 2009/45583

(57) ABSTRACT

Memory shortage is detected in a clustered container host system so that workloads can be shut down gracefully. A method of managing memory in a virtual machine (VM) in which containers are executed, includes the steps of: monitoring a dummy process that runs in the VM concurrently with the containers, the dummy process being configured to be terminated by an operating system of the VM under a low memory condition before any other processes running in the VM; upon detecting that the dummy process has been terminated, selecting one of the containers to be terminated; and terminating processes of the selected container.

### BACKGROUND

One of the features of workload management software, such as Kubernetes®, is management of workload lifecycles. This can include everything from their specification to their deployment and monitoring. Once the workloads are deployed and running, the underlying platform on which they are run may face the prospect of misbehaving workloads. Such misbehavior can manifest in a variety of forms, one being excessive use of compute resources, e.g., CPU time and memory. CPU time is a renewable resource, which means that as time progresses new cycles become available, and so scarcity of CPU time would likely just result in a slowdown in the execution of the workload. Excessive consumption of memory, on the other hand, is arguably a more severe problem, because memory does not get replenished and excessive memory consumption by one workload can negatively impact other workloads that are sharing the same underlying platform.

Mechanisms exist to limit the amount of memory that is allocated to a particular workload (e.g., resource quotas), but the determination of how much memory to allocate to the workload is manual and sometimes not bounded at all. In addition, there is an inherent tension between the desire to place as many workloads as possible onto a given set of resources in order to minimize operational costs, and allowing for workloads to have enough resource available to run without degradation. In view of these constraints, it is likely that workloads will encounter shortage of memory resources. When faced with such memory shortage, it would be desirable to detect misbehaving workloads and shut them down gracefully.

### SUMMARY

Embodiments provide techniques to detect memory shortage in a clustered container host system so that workloads can be shut down gracefully. According to one embodiment, a method of managing memory in a virtual machine (VM) in which containers are executed, includes the steps of: monitoring a dummy process (e.g., a canary process) that runs in the VM concurrently with the containers, the dummy process being configured to be terminated by an operating system of the VM under a low memory condition before any other processes running in the VM; upon detecting that the dummy process has been terminated, selecting one of the containers to be terminated; and terminating processes of the selected container. In one embodiment, the selected container is terminated gracefully. In another embodiment, where graceful termination is not possible, the selected container is terminated forcefully.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 is a block diagram of a clustered container host system in which embodiments may be implemented.

FIG. 2 illustrates additional components of the clustered container host system of FIG. 1.

FIG. 3 is a flow diagram illustrating the steps of a method for evicting workloads according to embodiments.

FIG. 4 is a command sequence diagram illustrating the steps carried out by different components of the clustered container host system prior to workload eviction.

### DETAILED DESCRIPTION

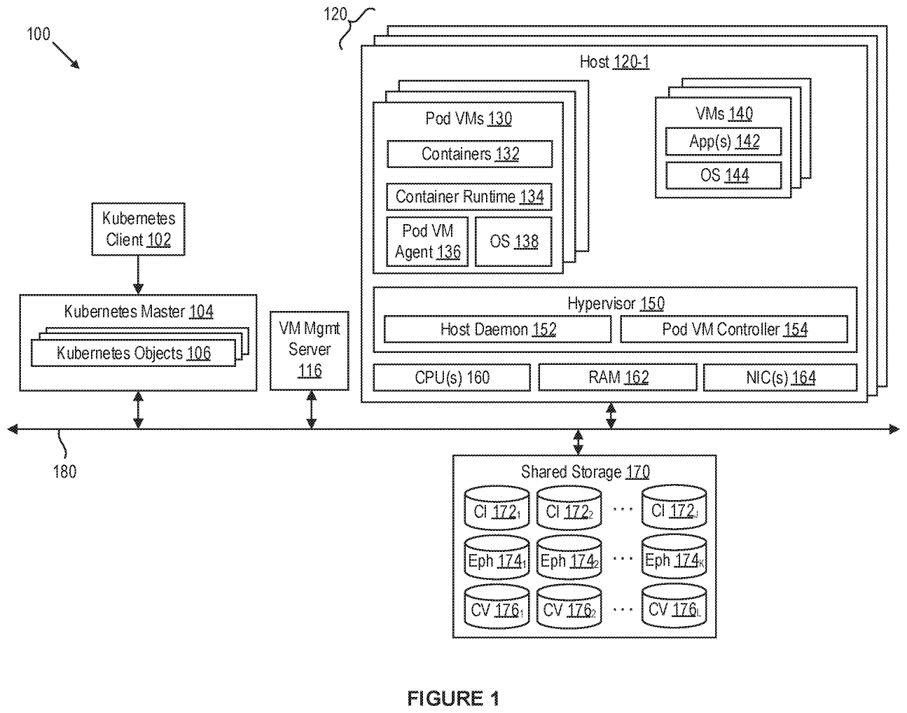

FIG. 1 is a block diagram of a clustered container host system 100, e.g., a Kubernetes system, in which embodiments may be implemented. System 100 includes a cluster of hosts 120 which may be constructed on a server grade hardware platform such as an x86 architecture platform. The hardware platform includes one or more central processing units (CPUs) 160, system memory, e.g., random access memory (RAM) 162, and one or more network interface controllers (NICs) 164. A virtualization software layer, also referred to herein as a hypervisor 150, is installed on top of the hardware platform. The hypervisor supports a virtual machine execution space within which multiple VMs may be concurrently instantiated and executed. As shown in FIG. 1, the VMs that are concurrently instantiated and executed in host 120-1 includes pod VMs 130, which also function as Kubernetes pods, and VMs 140. In addition, all of hosts 120 are configured in a similar manner as host 120-1 and they will not be separately described herein.

In the embodiment illustrated by FIG. 1, hosts 120 access shared storage 170 by using their NICs 164 to connect to a network 180. In another embodiment, each host 120 contains a host bus adapter (HBA) through which input/output operations (IOs) are sent to shared storage 170. Shared storage 170 may comprise, e.g., magnetic disks or flash memory in a storage area network (SAN). In some embodiments, hosts 120 also contain local storage devices (e.g., hard disk drives or solid-state drives), which may be aggregated and provisioned as a virtual SAN device.

VM management server 116 is a physical or virtual server that communicates with host daemon 152 running in hypervisor 150 to provision pod VMs 130 and VMs 140 from the hardware resources of hosts 120 and shared storage 170. VM management server 116 logically groups hosts 120 into a cluster to provide cluster-level functions to hosts 120, such as load balancing across hosts 120 by performing VM migration between hosts 120, distributed power management, dynamic VM placement according to affinity and anti-affinity rules, and high-availability. The number of hosts 120 in the duster may be one or many. Each host 120 in the cluster has access to shared storage 170 via network 180. VM management server 116 also communicates with shared storage 170 via network 180 to perform control operations thereon.

Kubernetes master 104 is a physical or virtual server that manages Kubernetes objects 106. Kubernetes client 102 represents an input interface for an application administrator or developer (hereinafter referred to as the “user”). It is commonly referred to as kubectl in a Kubernetes system. Through Kubernetes client 102, the user submits desired states of the Kubernetes system, e.g., as YAML scripts, to Kubernetes master 104. In response, Kubernetes master 104 schedules pods onto (i.e., assigns them to) different hosts 120 (which are also nodes of a Kubernetes cluster in the embodiments), and updates the status of pod objects 106. The pod VM controllers of the different hosts 120 periodically poll Kubernetes master 104 to see if any of the pods that have been scheduled to the node (in this example, the host) under its management and execute tasks to bring the actual state of the pods to the desired state as further described below.

Hypervisor 150 includes a host daemon 152 and a pod VM controller 154. As described above, host daemon 152 communicates with VM management server 116 to instantiate pod VMs 130 and VMs 140. Pod VM controller 154 manages the lifecycle of pod VMs 130 and determines when to spin up or delete a pod VM 130.

Each pod VM 130 has one or more containers 132 running therein in an execution space managed by container runtime 134. The lifecycle of containers 132 is managed by pod VM agent 136 (more generally referred to as the “container management process”). Both container runtime 134 and pod VM agent 136 run on top of an operating system (OS) 136. Each VM 140, is not a pod VM, has applications 142 running therein on top of an OS 144.

Each of containers 132 has a corresponding container image (CI) stored as a read-only virtual disk in shared storage 170. These read-only virtual disks are referred to herein as CI disks and depicted in FIG. 1 as CI 172_{1-J}. Additionally, each pod VM 130 has a virtual disk provisioned in shared storage 170 for reads and writes. These read-write virtual disks are referred to herein as ephemeral disks and are depicted in FIG. 1 as Eph 174_{1-K}. When a pod VM is deleted, its ephemeral disk is also deleted. In some embodiments, ephemeral disks can be stored on a local storage of a host because they are not shared by different hosts. Container volumes are used to preserve the state of containers beyond their lifetimes. Container volumes are stored in virtual disks depicted in FIG. 1 as CV 176_{1-L}.

In the embodiments illustrated herein, “namespaces” are created and used to divide resources, e.g., pod VMs, between multiple users. For example, a pod VM A in a namespace of one user may be authorized to use a CI X that is registered to that user. On the other hand, a pod VM B in a namespace of a different user may not be authorized to use CI X.

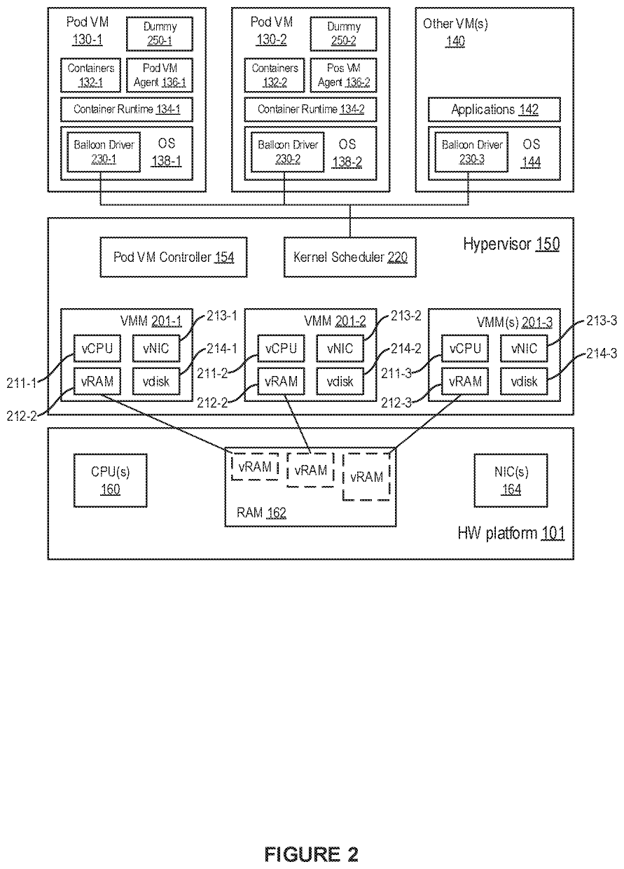

FIG. 2 illustrates additional components of the clustered container host system of FIG. 1. In FIG. 2, two pod VMs are illustrated, pod VM 130-1 and pod VM 130-2, alongside other (non-pod) VMs 140. Each of the VMs has an associated virtual machine monitor (VMM), depicted as VMM 201-1, VMM 201-2, and VMM 201-3, running as components of hypervisor 150. The VMMs provide a virtual hardware platform for their respective VMs.

The virtual hardware platform for pod VM 130-1 includes a virtual CPU 211-1, a virtual RAM 212-1, a virtual NIC 213-1, and a virtual disk 214-1. The virtual hardware platform for pod VM 130-2 includes a virtual CPU 211-2, a virtual RAM 212-2, a virtual NIC 213-2, and a virtual disk 214-2. The virtual hardware platform for pod VM 130-3 includes a virtual CPU 211-3, a virtual RAM 212-3, a virtual NIC 213-3, and a virtual disk 214-3.

As shown, the virtual RAM of the different VMs share RAM 162, which is part of the host's hardware platform 101. The size of the virtual RAM to be allocated to a VM varies depending on the VM's configuration and FIG. 2 depicts different sizes of the virtual RAM allocated to each of pod VM 130-1, pod VM 130-2, and other VMs 140.

Pod VM 130-1 has containers 132-1 running therein in an execution space managed by container runtime 134-1. The lifecycle of containers 132-1 is managed by pod VM agent 136-1. Both container runtime 134-1 and pod VM agent 136-1 run on top of an OS 136-1. Similarly, pod VM 130-2 has containers 132-2 running therein in an execution space managed by container runtime 134-2. The lifecycle of containers 132-2 is managed by pod VM agent 136-2. Both container runtime 134-2 and pod VM agent 136-2 run on top of an OS 136-2.

In addition, a dummy process (dummy process 250-1 and dummy process 250-2) is launched in each pod VM for execution alongside the containers on top of the OS. When the OS detects memory shortage, a kernel process known as out-of-memory killer is executed by the OS. This kernel process, when triggered, assigns a score to each process running in the pod VM according to some heuristic and terminates processes in the order of their assigned scores, e.g., from high to low. In the embodiments illustrated herein, this kernel process is modified to always assign to the dummy process a score higher than that of any other process (even potentially misbehaving processes with excessive memory consumption). Having such a high score ensures that the dummy process is the first process to be terminated when the OS detects memory shortage.

FIG. 2 also illustrates components for performing memory ballooning. Memory ballooning is a technique known in the art that is employed by a host with VMs running therein when the host is under memory pressure. In particular, when a kernel scheduler 220, which is a component of hypervisor 150, detects memory pressure in the host, it communicates with balloon drivers 230-1, 230-2, 230-3 of all of the VMs running in the host to “inflate” their respective balloons, which causes memory of a certain target size designated by kernel scheduler 220 to be allocated to the balloon drivers for reclaiming by kernel scheduler 220 as needed. As a result, memory pressure in the, host may be relieved. However, memory pressure in the VMs will increase and possibly cause the out-of-memory killer to be triggered in the VMs.

In one embodiment, each VM is assigned a class of service. For example, a VM in a high class of service has all of its memory reserved, and a VM in a low class of service has none of its memory reserved, while a VM in an intermediate class of service has some of its memory reserved. Similarly, a VM in a high class of service is configured to not allow memory ballooning, and a VM in a low class of service is configured to allow memory ballooning, while a VM in an intermediate class of service is configured to allow some memory ballooning.

In another embodiment, each container is assigned a class of service and as among containers running in the same pod VM, the container with the lowest class of service is selected for termination first.

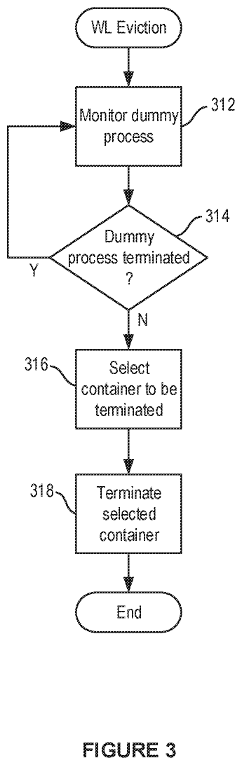

FIG. 3 is a flow diagram illustrating the steps of a method for evicting workloads according to embodiments. The steps of FIG. 3 are carried out by a pod VM agent running in a pod VM. The method begins at step 312, where the pod VM agent continually monitors a dummy process that has been launched in the pod VM to run alongside containers in the pod VM. When the dummy process terminated as determined at step 314, the pod VM agent selects a container to be terminated at step 316. In one embodiment, the container to be terminated is selected based on a class of service assigned to all containers currently running in the pod VM. Then, at step 318, the pod VM agent terminates all processes in the selected container in an orderly manner that ensures a graceful shutdown of the selected container, e.g., according to an order that is implied by the container's internal dependencies.

In the embodiments, the termination of the dummy process acts as a signal to the pod VM agent that the pod VM is under memory pressure. As such, the dummy process is also referred to as a “canary” process. The memory pressure may be caused rogue containers running in the pod VM or the memory pressure may be caused by the host coming under memory pressure leading to an inflation of the memory balloon in the pod VM. It should be recognized, however, that VMs that are assigned a high class of service may not be affected or may be less affected by the host coming under memory pressure relative to VMs that are assigned lower class of service (e.g., VMs assigned intermediate or low class of service).

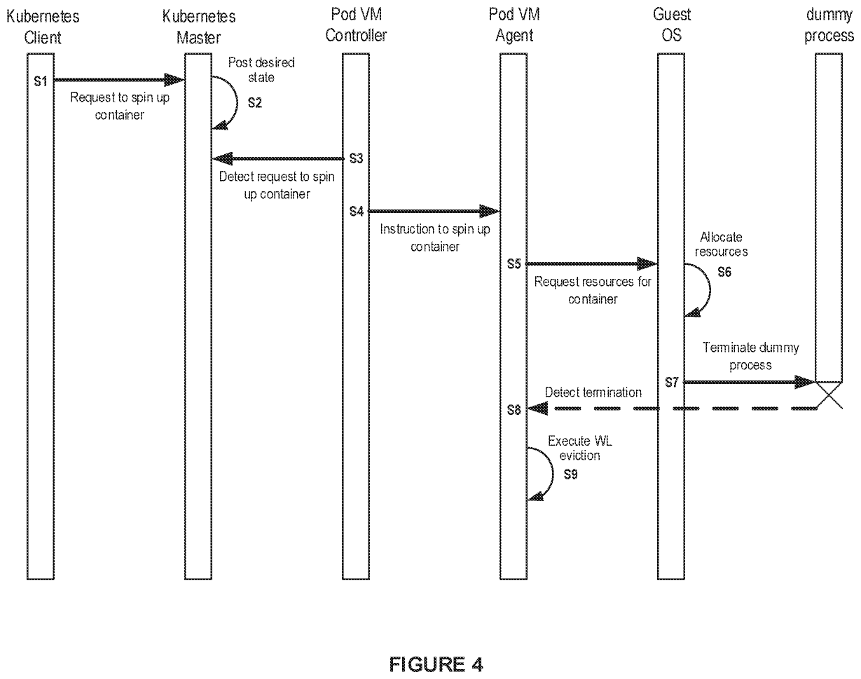

FIG. 4 is a command sequence diagram illustrating the steps carried out by different components of the clustered container host system prior to workload eviction. The command sequence of FIG. 4 begins when the user at 51 requests a container to be spun up in a pod VM. In the embodiments illustrated herein, the user inputs that request using a Kubernetes client and that request gets posted at step 52 by the Kubernetes master as a desired state. At step S3, the pod VM controller of the pod VM, upon polling the Kubernetes master, recognizes that there is a pending request to spin up a container in a pod VM under its control. Then, at step S4, the pod VM controller issues an instruction to the corresponding pod VM agent to spin up the container. The pod VM agent at step S5 in turn requests the guest OS for resources (CPU, memory, etc.) for spinning up the container. The guest OS at step S6 attempts to allocate the requested resources in step S6. If the guest OS cannot allocate sufficient memory to meet the request, the out-of-memory killer in the guest OS is triggered, causing the dummy process to be terminated at step S7. At step S8, the pod VM agent detects that the dummy process has been terminated and carries out steps 316 and 318 of FIG. 3.

In the embodiments described above, upon detecting memory shortage, the guest OS executes the out-of-memory killer, which in turn terminates the dummy process. This out-of-memory killer may be implemented as a watchdog process that monitors memory consumption or a callback that is invoked when a request for memory could not be served.

Further, in the embodiments described above, the condition for triggering the out-of-memory killer in the guest OS is generally when the guest OS detects memory shortage. This may happen, e.g., when the guest OS cannot allocate sufficient memory to meet the request to spin up a container as described above in conjunction with FIG. 4. This may also happen when a currently running process consumes increasing amounts of memory over time such that memory usage within a VM reaches a point where the guest OS cannot allocate any more memory to that process.

Embodiments do not rely on resource quotas as in the prior art but work in conjunction with them. That is, if one of the workloads running on a compute node has known upper bounds for memory consumption, these can be enforced in the embodiments. In addition, these upper bounds may be considered when making an eviction decision.

The embodiments offer an improved solution over prior art techniques which may: (1) kill a process or a container in another pod different from the one in which a rogue container is running; (2) kill a process within a container that a pod has no way of recovering from; and (3) kill all the processes running in the container at once or in no particular order so that the container cannot be shut down gracefully.

Clustered container host system 100 has been described herein as a Kubernetes system. However, the Kubernetes system is merely one embodiment of clustered container host system 100. Clustered container host systems according to other embodiments may be managed by any other workload management software that enables one or more containers to be run inside VMs.

The embodiments described herein may employ various computer-implemented operations involving data stored in computer systems. For example, these operations may require physical manipulation of physical quantities. Usually, though not necessarily, these quantities may take the form of electrical or magnetic signals, where the quantities or representations of the quantities can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of managing memory in a virtual machine (VM) in which containers are executed, said method comprising:
monitoring a dummy process that runs in the VM concurrently with the containers, the dummy process being configured to be terminated by an operating system of the VM under a low memory condition before any other processes running in the VM;
upon detecting that the dummy process has been terminated, selecting one of the containers to be terminated; and
terminating processes of the selected container.

2. The method of claim 1, wherein the containers are each assigned a class of service and the selected container has a lowest class of service.

3. The method of claim 1, wherein the processes of the selected container are terminated in a predetermined order.

4. The method of claim 1, wherein the VM is one of a plurality of virtual machines that are running in a host and share memory resources of the host.

5. The method of claim 4, wherein each of the virtual machines has a driver that is allocated a portion of the memory resources of the host when the host is under memory pressure.

6. The method of claim 1, wherein the operating system detects the low memory condition when the operating system cannot serve a request for memory.

7. A non-transitory computer readable medium comprising instructions, which when executed on a processor cause the processor to carry out a method of managing memory in a virtual machine (VM) in which containers are executed, said method comprising:
monitoring a dummy process that runs in the VM concurrently with the containers, the dummy process being configured to be terminated by an operating system of the VM under a low memory condition before any other processes running in the VM;
upon detecting that the dummy process has been terminated, selecting one of the containers to be terminated; and
terminating processes of the selected container.

8. The non-transitory computer readable medium of claim 7, wherein the containers are each assigned a class of service and the selected container has a lowest class of service.

9. The non-transitory computer readable medium of claim 7, wherein the processes of the selected container are terminated in a predetermined order.

10. The non-transitory computer readable medium of claim 7, wherein the VM is one of a plurality of virtual machines that are running in a host and share memory resources of the host.

11. The non-transitory computer readable medium of claim 10, wherein each of the virtual machines has a driver that is allocated the memory resources of the host when the host is under memory pressure.

12. The non-transitory computer readable medium of claim 7, wherein the operating system detects the low memory condition when the operating system cannot serve a request for memory.

13. A host computer in which at least a first virtual machine and a second virtual machine are running, wherein the first virtual machine includes a container management process that executes the steps of:
monitoring a dummy process that runs in the first virtual machine concurrently with containers, the dummy process being configured to be terminated by an operating system of the first virtual machine under a low memory condition before any other processes running in the first virtual machine;
upon detecting that the dummy process has been terminated, selecting one of the containers to be terminated; and
terminating processes of the selected container.

14. The host computer of claim 13, wherein the containers running in the first virtual machine are each assigned a class of service and the selected container has a lowest class of service.

15. The host computer of claim 13, wherein the processes of the selected container are terminated in a predetermined order.

16. The host computer of claim 13, wherein the first virtual machine and the second virtual machine share memory resources.

17. The host computer of claim 16, wherein each of the first and second virtual machines has a driver that is allocated the memory resources when the host computer is under memory pressure.

18. The host computer of claim 13, wherein the operating system detects the low memory condition when the operating system cannot serve a request for memory.

19. The host computer of claim 13, wherein the second virtual machine has containers running therein.

20. The host computer of claim 19, wherein the second virtual machine includes a container management process that executes the steps of:
monitoring a dummy process that runs in the second virtual machine concurrently with the containers of the second virtual machine, the dummy process of the second virtual machine being configured to be terminated by an operating system of the second virtual machine under a low memory condition before any other processes running in the second virtual machine;
upon detecting that the dummy process of the second virtual machine has been terminated, selecting one of the containers the second virtual machine to be terminated; and
terminating processes of the selected container of the second virtual machine.
